(19) United States
(12) Patent Application Publication
(10) Pub. No.: US 2019/0225790 A1
(43) Pub. Date: Jul. 25, 2019

(54) THERMOPLASTIC RESIN COMPOSITION FOR ELECTRIC WIRE COATING AND ELECTRIC WIRE USING THE SAME

(71) Applicant: RIKEN TECHNOS CORPORATION, Tokyo (JP)

(72) Inventor: Nanami HORIUCHI, Tokyo-to (JP)

(73) Assignee: RIKEN TECHNOS CORPORATION, Tokyo-to (JP)

(21) Appl. No.: 16/313,564

(22) PCT Filed: Jun. 27, 2017
(86) PCT No.: PCT/JP2017/023596

§ 371 Date: Dec. 27, 2018

(30) Foreign Application Priority Data
Jun. 29, 2016 (JP) 2016-128280

(51) Int. Cl. C08L 27/06; C08L 23/08; C08K 5/12; C08L 51/00; C08K 5/00

(52) U.S. Cl. CPC C08L 27/06; C08L 23/0853; C08K 5/12; C08L 15/00; C08K 5/0016; C08L 2203/202; C08L 51/003

(57) ABSTRACT

There is provided a thermoplastic resin composition suitable for coating an electric wire with high abrasion resistance, excellent cold resistance and flexibility at a low temperature, and wherein the electric wire is mounted on automobiles, particularly, which has a small diameter and a thin coating thickness.

### TECHNICAL FIELD

The present invention relates to a thermoplastic resin composition suitable as a material for covering an electric wire, and to an electric wire suitable as a material for a wire harness to be mounted on electric wires, in particular, automobiles and the like using the thermoplastic resin composition.

### BACKGROUND ART

In recent years, from the viewpoint of driving a car safely and comfortably, automobiles are undergoing electronic control. Further, diversification of equipment mounted on a car and electronic control are advanced. As a result, the amount of wires installed in automobiles has increased significantly. On the other hand, from the viewpoint of improving fuel economy, weight reduction of automobiles is promoted. Since the amount of electric wire loading has increased significantly as described above, reduction in the weight of electric wires is also an important subject, and reduction in the diameter of electric wires and thinning of electric wire coating thickness are being advanced. However, there has been a problem that it is necessary to greatly improve the wear resistance of the electric wire covering material in order to advance the reduction in the diameter of the electric wire and the thinning of the electric wire coating thickness. Therefore, techniques for addressing the reduction in the diameter of the electric wire and thinning of the wire coating thickness, and improving the abrasion resistance have been proposed (for example, Patent Documents 1 and 2). However, in view of the fact that electric wires to be mounted on automobiles require cold resistance to withstand use in cold districts and flexibility at low temperatures, these techniques cannot provide enough cold resistance and flexibility at low temperatures.

Conventionally, as a technique for improving the cold resistance and flexibility at low temperature of a vinyl chloride resin composition, a technique of blending an ethylene-vinyl acetate copolymer is known. However, in order to impart sufficient cold resistance as a covering material for electric wires to be mounted on an automobile and flexibility at low temperature, it is necessary to add ethylene-vinyl acetate copolymer whose content of constituent units derived from vinyl acetate is about 10 to 30% by mass. Consequently, abrasion resistance of the vinyl chloride resin composition is insufficient. Therefore, it has been proposed to incorporate a chlorinated ethylene-vinyl acetate copolymer (Non-Patent Document 1). However, there is a problem that it is difficult to maintain a balance between cold resistance and abrasion resistance.

### PRIOR ART DOCUMENTS

### Patent Documents

Patent Document 1: JP H10-241462 A
Patent Document 2: JP 2015-143299 A
Patent Document 3: JP 2000-086858 A

### Non-Patent Documents

Non-Patent Document 1: TOYO SODA REPORT Vol. 13, 1 (1969)

### SUMMARY OF THE INVENTION

### Problem to be Solved by the Invention

An object of the present invention is to provide a thermoplastic resin composition which has high abrasion resistance and is suitable as a coating material for electric wires, particularly, electric wires having a small diameter and a thin coating thickness. A further object of the present invention is to provide a thermoplastic resin composition suitable for coating an electric wire which has high abrasion resistance, excellent cold resistance and flexibility at a low temperature and is mounted on automobiles, particularly, which has a small diameter and a thin coating thickness.

The present inventors have diligently studied and consequently found out that the above object can be achieved by a specific vinyl chloride resin composition comprising a copolymer of an ethylene-vinyl acetate copolymer and vinyl chloride.

Specifically, the present invention is as defined below.

A thermoplastic resin composition for an electric wire coating, the thermoplastic resin composition comprising

(A) 100 parts by mass of a thermoplastic resin and

(B) 10 to 50 parts by mass of a plasticizer,

the thermoplastic resin (A) comprising

(a1) 50 to 95% by mass of a vinyl chloride resin and

(a2) 50 to 5% by mass of one or more selected from the group consisting of: a copolymer of an ethylene-vinyl acetate copolymer and vinyl chloride; and a copolymer of an ethylene-vinyl acetate copolymer, vinyl chloride and a monomer copolymerizable with the vinyl chloride, wherein the total of the component (a1) and the component (a2) is 100% by mass.

A second invention is the thermoplastic resin composition for an electric wire coating according to the first invention, wherein the component (a2) is one or more selected from the group consisting of: a graft copolymer of an ethylene-vinyl acetate copolymer and vinyl chloride; and a graft copolymer of an ethylene-vinyl acetate copolymer, vinyl chloride and a monomer copolymerizable with the vinyl chloride.

A third invention is the thermoplastic resin composition for an electric wire coating according to the first or second invention, wherein the plasticizer (B) is one or more selected from the group consisting of polyester plasticizers, trimellitates plasticizers and phthalates plasticizers.

A fourth invention is the thermoplastic resin composition for an electric wire coating according to any one of the first to third invention further comprising 1 to 15 parts by mass of one or more component (C) selected from the group consisting of a nitrile rubber based material other than fully cross-linked nitrile rubber, a core shell rubber and a thermoplastic elastomer having a hydrophilic functional group, with respect to 100 parts by mass of the thermoplastic resin (A).

A fifth invention is an electric wire comprising the thermoplastic resin composition for an electric wire coating according to any one of the first to forth invention.

A sixth invention is a wire harness comprising the electric wire according to the fifth invention.

### Effect of the Invention

The thermoplastic resin composition of the present invention is excellent in abrasion resistance. The preferred thermoplastic resin composition of the present invention is excellent in abrasion resistance, cold resistance, and flexibility at low temperature. For this reason, it can be suitably used as a coating material for electric wires, in particular, electric wires with a small diameter and a thin coating thickness. The obtained electric wire can suitably be used as a wire harness. The obtained electric wire can be suitably used particularly as an electric wire for mounting on automobiles.

### DETAILED DESCRIPTION OF THE INVENTION

The thermoplastic resin composition of the present invention contains 100 parts by mass of a thermoplastic resin (A) and 10 to 50 parts by mass of plasticizer (B). The thermoplastic resin (A) comprises (a1) 50 to 95% by mass of a vinyl chloride resin and (a2) 50 to 5% by mass of one or more selected from the group consisting of: a copolymer of an ethylene-vinyl acetate copolymer and vinyl chloride; and a copolymer of an ethylene-vinyl acetate copolymer, vinyl chloride and a monomer copolymerizable with the vinyl chloride, wherein the total of the component (a1) and the component (a2) is 100% by mass.

[(a1) Vinyl Chloride Resin]

The component (a1) is a vinyl chloride resin, preferably a vinyl chloride homopolymer. The component (a1) may contain a component unit, which is derived from a monomer copolymerizable with vinyl chloride, as long as the quantity of the component unit is small (usually 5% by mass or less, preferably 3% by mass or less, more preferably 1% by mass or less). The monomer copolymerizable with vinyl chloride will be described later in the description of the component (a2).

The average degree of polymerization of the component (a1) calculated from the specific viscosity in accordance with the Annex of JIS K 6720-2: 1999 is preferably 800 or more, more preferably 1000 or more from the viewpoint of abrasion resistance. On the other hand, the average degree of polymerization of the component (a1) is preferably 3000 or less, more preferably 2600 or less, from the viewpoint of formability.

As the component (a1), one kind or a mixture of two or more kinds of them can be used.

[(a2) Copolymer of Ethylene-Vinyl Acetate Copolymer and Vinyl Chloride and the Like]

The component (a2) is one or more selected from the group consisting of a copolymer of an ethylene-vinyl acetate copolymer and vinyl chloride; and a copolymer of an ethylene-vinyl acetate copolymer, vinyl chloride and a monomer copolymerizable with vinyl chloride. Preferred representative example of the component (a2) is one or more selected from the group consisting of a graft copolymer of an ethylene-vinyl acetate copolymer and vinyl chloride; and a graft copolymer of an ethylene-vinyl acetate copolymer, vinyl chloride and a monomer copolymerizable with vinyl chloride. The component (a2) is excellent in miscibility with the component (a1) and functions to improve cold resistance, flexibility at low temperature, impact resistance and weather resistance.

The component (a2) can be obtained by copolymerizing vinyl chloride or by copolymerizing vinyl chloride and a monomer copolymerizable with vinyl chloride in the presence of an ethylene-vinyl acetate copolymer. The component (a2) can be obtained typically by graft copolymerizing vinyl chloride or graft copolymerizing vinyl chloride and a monomer copolymerizable with vinyl chloride in the presence of ethylene-vinyl acetate. As a method of the above copolymerization includes for example, a method described in JP-A-S59-1824248 and the like.

From the viewpoints of abrasion resistance and heat resistance, the content of the constitutional unit derived from vinyl chloride in component (a2) is preferably 50% by mass or more, more preferably 70% by mass or more. On the other hand, it is preferably 95% by mass or less, more preferably 93% by mass or less from the viewpoints of cold resistance and flexibility at low temperature.

Examples of the monomer copolymerizable with the above vinyl chloride include vinylidene chloride, ethylene, propylene, (meth) acrylic acid, vinyl acetate, methyl (meth) acrylate, ethyl (meth) acrylate, styrene, isobutylene, butadiene, Isoprene, acrylonitrile, maleic anhydride and the like. As the monomer copolymerizable with vinyl chloride, one or more of these monomers can be used. In the present specification, (meth) acrylic acid refers to methacrylic acid or acrylic acid.

The content of the constitutional unit derived from the monomer copolymerizable with vinyl chloride in the above component (a2) is not particularly limited, provided that the constitutional unit derived from the ethylene-vinyl acetate copolymer is excluded, but is preferably It may be preferably 5% by mass or less, more preferably 0 to 3% by mass. When the component (a2) is a graft copolymer obtained by graft copolymerizing vinyl chloride and a monomer copolymerizable with vinyl chloride in the presence of an ethylene-vinyl acetate copolymer, the content of the constitutional unit derived from the monomer copolymerizable with vinyl chloride in the graft chain is not particularly limited, but it is preferably 5% by mass or less, more preferably 0 to 3% by mass.

The ethylene-vinyl acetate copolymer used as the raw material of the component (a2) is explained below. From the viewpoint of miscibility with the component (a1), the content of the constituent unit derived from vinyl acetate in the ethylene-vinyl acetate copolymer is preferably 5% by mass or more (the content of the constituent unit derived from ethylene is 95% by mass or less), more preferably 10% by mass or more (content of constitutional units derived from ethylene is 90% by mass or less). On the other hand, from the viewpoint of abrasion resistance, it is preferably 40% by mass or less (the content of the constitutional unit derived from ethylene is 60% by mass or more), more preferably 30% by mass or less (the content of the constituent unit derived from ethylene is 70% by mass or more).

Based on the specific viscosity of the component (a2) in accordance with the appendix of JIS K 6720-2: 1999, the average polymerization degree calculated on the assumption that the relationship between the viscosity and the polymerization degree is the same as that in the case of the vinyl chloride homopolymer, and is preferably 500 to 1200, more preferably 600 to 1100 from the viewpoints of abrasion resistance and miscibility with the component (a1).

A commercially available example of the component (a2) includes the followings; a graft copolymer of ethylene-vinyl acetate copolymer and vinyl chloride available from Taiyo PVC Corporation “TG-110 (trade name)” (average polymerization degree 910, content of constitutional units derived from vinyl chloride 93.7% by mass), “TG-120 (trade name)” (average polymerization degree 710, content of constituent units derived from vinyl chloride 90.4 mass %), and “TG-130 (trade name)” (average polymerization degree 870, content of constituent units derived from vinyl chloride: 87.2% by mass)”; a graft copolymer of ethylene-vinyl acetate copolymer and vinyl chloride available from Sekisui Chemical Co., Ltd. “PVC-TG H1100 trade name)” (average degree of polymerization 1050, content of constituent units derived from vinyl chloride 91.0% by mass), and the like.

From the viewpoints of abrasion resistance and moldability, regarding the compounding ratio of the component (a1) and the component (a2), the component (a1) is usually 50% by mass or more (the component (a2) is 50% by mass or less), preferably 60% by mass or more (the component (a2) is 40% by mass or less). On the other hand, from the viewpoint of cold resistance and flexibility at low temperature, the compounding ratio of the above component (a1) is usually 95% by mass or less (the compounding ratio of the above component (a2) is by 5% by mass or more), preferably 90% by mass or less (the component (a2) is 10% by mass or more). Here, the total of the component (a1) and the component (a2) is 100% by mass.

### [(B) Plasticizer]

The component (B) is a plasticizer. As the component (B), a plasticizer used in the vinyl chloride resin composition can be appropriately selected and used according to the purpose.

Examples of the plasticizer include phthalate ester plasticizer, trimellitate ester plasticizer, pyromellitic acid ester plasticizer, adipate ester plasticizer, itaconic ester plasticizer, citrate ester plasticizer, cyclohexanedicarboxylate plasticizer, epoxy plasticizer, and the like. These plasticizers may be used singly or in combination of two or more kinds.

Examples of the plasticizer include polyester plasticizer using polyhydric alcohols such as ethylene glycol, diethylene glycol, triethylene glycol, 1,2-propylene glycol, 1,3-propylene glycol, 1,3-butanediol, 1,4-butanediol, 1,5-hexanediol, 1,6-hexanediol, neopentyl glycol and the like; and polycarboxylic acids such as oxalic acid, malonic acid, succinic acid, glutaric acid, adipic acid, trimellitic acid, pimelic acid, suberic acid, maleic acid, azelaic acid, sebacic acid, fumaric acid, phthalic acid, isophthalic acid, terephthalic acid and the like, and polyester plasticizer optionally using monohydric alcohol or monocarboxylic acid as a stopper.

Examples of the phthalate plasticizer include dibutyl phthalate, butylhexyl phthalate, diheptyl phthalate, di(2-ethylhexyl) phthalate, diisononyl phthalate, diisodecyl phthalate, diundecyl phthalate, ditridecyl phthalate, dilauryl phthalate, dicyclohexyl phthalate, dioctyl terephthalate, and the like. These phthalate ester plasticizers may be used singly or in combination of two or more kinds.

Examples of the trimellitate ester type plasticizer include tri(2-ethylhexyl)trimellitate, tri(n-octyl)trimellitate, and tri(isononyl)trimellitate. These trimellitate ester plasticizers may be used singly or in combination of two or more kinds.

Examples of the adipate ester plasticizer include bis(2-ethylhexyl)adipate, dioctyladipate, diisononyladipate, diisodecyladipate, and the like. These adipate ester plasticizers may be used singly or in combination of two or more kinds.

Examples of the epoxy plasticizer include epoxidized soybean oil, epoxidized linseed oil, epoxidized fatty acid octyl ester, epoxidized fatty acid alkyl ester and the like. These epoxy plasticizers may be used singly or in combination of two or more.

Examples of the plasticizer include other plasticizers such as trimellitic acid plasticizer, tetrahydrophthalic acid diester plasticizer, glycerin ester plasticizer, epoxyhexahydrophthalic acid diester plasticizer, isosorbide type plasticizer, phosphate plasticizer, azelaic acid plasticizer, sebacic acid plasticizer, stearic acid plasticizer, citric acid plasticizer, pyromellitic acid plasticizer, biphenyltetracarboxylic acid plasticizer, chlorine plasticizer, and the like. These plasticizers may be used singly or in combination of two or more kinds.

Among these, polyester plasticizer, trimellitate ester plasticizer, phthalate ester plasticizer, and epoxy plasticizer are preferable as the above component (B).

As the above component (B), one kind or a mixture of two or more kinds of them can be used.

The blending amount of the above component (B) is usually 10 parts by mass or more, preferably 15 parts by mass or more on the basis of 100 parts by mass of the above component (A) from the viewpoints of cold resistance, moldability, and flexibility. On the other hand, from the viewpoint of abrasion resistance, it is usually 50 parts by mass or less, preferably 45 parts by mass or less.

### [(C) Rubber or Elastomer]

The thermoplastic resin composition of the present invention preferably further comprises the above component (C). Cold resistance can be further improved by including the component (C).

Examples of the above component (C) include nitrile rubber materials other than perfectly cross-linked nitrile rubbers such as uncross-linked nitrile rubber, partially cross-linked nitrile rubber and hydrogenated partially cross-linked nitrile rubber; core-shell rubbers such as methacrylic acid ester-styrene/butadiene rubber copolymer, acrylonitrile-styrene/butadiene rubber copolymer, acrylonitrile-styrene/ethylene-propylene rubber copolymer, acrylonitrile-styrene/acrylate ester rubber copolymer, methacrylic acid ester/acrylate ester rubber copolymer, and methacrylic acid ester-acrylonitrile/acrylate ester rubber copolymer and the like; thermoplastic elastomer comprising hydrophilic functional groups such as polyurethane thermoplastic elastomer, polyester thermoplastic elastomer, modified styrene thermoplastic elastomer, modified olefin thermoplastic elastomer, partially cross-linked acrylic thermoplastic elastomer, and modified ethylene copolymer thermoplastic elastomers. As the above component (C), one kind or a mixture of two or more kinds of them can be used.

The amount of component (C) is preferably 15 parts by mass or less, more preferably 12 parts by mass or less on the basis of 100 parts by mass of component (A) from the viewpoints of abrasion resistance and moldability. On the other hand, the lower limit of the compounding amount of the component (C) is not particularly limited since it is an optional component, but from the viewpoint of reliably obtaining the effect of improving the cold resistance by the component (C), it is preferably 1 part by mass or more, 2 parts by mass or more.

If desired, the thermoplastic resin composition of the present invention may further contain a thermoplastic resin, a pigment, inorganic filler, organic filler, flame retardant, flame retardant aid, lubricant, antioxidant, thermal stabilizer, weathering stabilizer, release agent, antistatic agent, metal deactivator, surfactant and the like, other than the component (a1), the component (a2), and the component (C) as long as the object of the present invention can be achieved.

The thermoplastic resin composition of the present invention can be produced by melt kneading the above component (A), the above component (B) and optionally used optional components at the same time or in any order using any melt kneader. Preferably, the thermoplastic resin composition of the present invention can be produced by melt-kneading these components using a pressure kneader at a resin temperature of 150 to 180° C.

Examples of the melt kneader include a batch kneader such as a pressure kneader and a mixer; extrusion kneading machines such as a single screw extruder, a co-rotating twin screw extruder, and an opposite direction rotary twin screw extruder; a calendar roll kneader, and the like. These may be used arbitrarily in combination.

The resulting thermoplastic resin composition can be pelletized by an arbitrary method and then molded into an arbitrary article by an arbitrary method. The pelletization can be carried out by a method such as hot cutting, strand cutting and under water cutting.

The electric wire of the present invention is an electric wire including the thermoplastic resin composition of the present invention. The electric wire of the present invention is preferably an electric wire used as a material of a wire harness mounted on an automobile or the like. The method of molding the electric wire of the present invention using the thermoplastic resin composition of the present invention is not particularly limited. The above method includes, for example, a method for coating the periphery of an arbitrary conductor, an arbitrary insulating coated conductor, or the twisted several conductors with the thermoplastic resin composition, by using an electric wire forming apparatus comprising an arbitrary extruder and an arbitrary die.

### EXAMPLES

Hereinafter, the present invention will be explained by way of Examples, but the scope of the present invention is not limited thereto.

### <Raw Materials Used in Examples>

### Raw Materials

### (a1) Vinyl Chloride Resin:

(a1-1) Vinyl chloride homopolymer available from Shin-Etsu Chemical Co., Ltd. “TK-1300 (trade name)”. Average polymerization degree is 1300.

(a1-2) Vinyl chloride homopolymer available from Shin-Etsu Chemical Co., Ltd. “TK-2500 LS (trade name)”. Average polymerization degree is 2500.

### (a2) Copolymer of Ethylene-Vinyl Acetate Copolymer and Vinyl Chloride and the Like:

(a2-1) Graft copolymer of ethylene-vinyl acetate copolymer and vinyl chloride available from Taiyo PVC Co., “TG-130 (trade name)”. An average polymerization degree of 870, a content of constituent units derived from vinyl chloride of 87.2% by mass, a content of constituent units derived from vinyl acetate of 3.1% by mass (a content of constituent units derived from vinyl acetate in the ethylene-vinyl acetate copolymer: 24.2% by mass), a content of constituent units derived from ethylene: 9.7% by mass.

(a2-2) Graft copolymer of ethylene-vinyl acetate copolymer and vinyl chloride available from SEKISUI CHEMICAL INDUSTRY CO., LTD. “PVC-TG H1100 (trade name)”. An average polymerization degree of 1050, a content of constituent units derived from vinyl chloride of 91.0% by mass, a content of constituent units derived from vinyl acetate of 2.0% by mass (a content of constituent units derived from vinyl acetate in the ethylene-vinyl acetate copolymer: 22.2% by mass), a content of constituent units derived from ethylene: 7.0% by mass.

(a2′-1) Ethylene-vinyl acetate copolymer “Evaflex EV 560 (trade name)” available from Dupont Mitsui Polychemicals Co., Ltd. A content of constituent unit derived from vinyl acetate of 14% by mass, a content of constituent unit derived from ethylene of 86% by mass.

### (B) Plasticizer:

(B-1) Trimellitate ester plasticizer (tri(2-ethylhexyl)trimellitate) available from Kao Corporation “TOTM (trade name)”.

(B-2) Trimellitate ester plasticizer (tri(n-octyl)trimellitate) available from Kao Corporation “TRIMEX N-08 (trade name)”.

(B-3) phthalate plasticizer “PL-200 (trade name)” available from Siege Ester Co., Ltd. Dialkyl, (9 to 11 carbon atoms) phthalate.

(B-4) Polyester plasticizer “SA-730 (trade name)” available from ADEKA CORPORATION. Adipic acid polyester.

### (C) Ingredients:

(C-1) Partially cross-linked nitrile rubber “PNC-48 (trade name)” available from JSR Corporation. A content of constituent units derived from acrylonitrile: 30% by mass.

(C-2) Core-shell rubber (methacrylic ester-styrene/butadiene rubber copolymer) “C-215A (trade name)” available from Mitsubishi Rayon Co., Ltd.

(C-3) Polyester thermoplastic elastomer “Hytrel 4057 (trade name)” available from Du Pont-Toray Co., Ltd. Hardness 90 A (according to ASTM D 2240, 15 second value measured with a durometer-A hardness tester).

(C-4) Polyurethane thermoplastic elastomer “PANDEX T-1180N (trade name)” available from DIC COVESTROPOLYMER CO., LTD. Hardness 81 A (according to ASTM D 2240, 15 second value measured with a durometer-A hardness tester).

### Examples 1-23

The compounds having the compounding ratio shown in any one of Tables 1 to 3 was melt-kneaded at a resin temperature of 180° C. by using a pressure kneader with a capacity of 20 L in order to obtain thermoplastic resin compositions. The following tests (1) to (6) were carried out. The results are shown in any one of Tables 1 to 3.

### Preparation of Pressed Sheet

Milled sheets were prepared by using a thermoplastic resin composition and using a two-roll 8 inches in size. Next, milled sheets were preheated for 2 minutes at a temperature of 180° C. using a hot press machine, subsequently pressurized for 2 minutes under the conditions of a temperature of 180° C. and a pressure of 50 kg/cm². After that, the milled sheets were pressed for 2 minutes under conditions of a temperature of 25° C. and a pressure of 20 kg/cm² in order to prepare pressed sheets of a predetermined thickness (1 mm, 2 mm, or 6.3 mm).

### Measurement Method

(1) Hardness:

According to ASTM D 2240, a 5 second value was measured with a durometer-D hardness tester. A press sheet of 6.3 mm thickness was used as a test piece.

(2) Cold Resistance:

The embrittlement temperature was measured in accordance with JIS K 7216-1980 cited in JIS K 6723-1995, except that the minimum temperature at which all three test pieces did not break was taken as the embrittlement temperature. A specimen of 38 mm in length and 6 mm in width (A-Type of the standard) was taken from a pressed sheet having a thickness of 2 mm and used. Methanol was used as the medium, the temperature was adjusted to the test temperature, three specimens were attached to the grip, immersed in the medium for 3 minutes, the temperature was recorded, and a blow was applied once with a striking hammer. The term “breakage” as used herein means that the test piece is separated into two or more pieces, and the term does not mean that the creation of a cleavage or a crack.

(3) Abrasion Resistance:

Abrasion resistance was evaluated by a blade reciprocating test method. A metal plunger (width 3 mm) using C type hard steel wire (wire diameter 0.45 mm) defined in JIS G 3521-1991 was brought into contact with the center in the width direction of the length/width surface of the test piece, and a load of 14 N was added. Next, this metal plunger was reciprocated at a speed of 60 times reciprocatingly per minute for a length of 20 mm, and the number of times of reciprocation until the sheet was broken was measured. As a test piece, a strip of 50 mm in length and 20 mm in width obtained by punching from a 1 mm thick pressed sheet was used. The abrasion resistance is preferably 300 times or more, more preferably 400 times or more, even more preferably 500 times or more. The higher the abrasion resistance is the better.

(4) Low Temperature Flexibility 1:

According to 9.8 Flexible Temperature of JIS K 677-1999, the rigidity ratio (MPa) was obtained from the helix angle at a measurement temperature of −25° C. using a Crushberg flexible temperature measuring instrument. A specimen having the shape shown in the above-mentioned standard FIG. 2 obtained by punching from a 1 mm-thickness pressed sheet was used.

(5) Low Temperature Flexibility 2:

Rigidity (MPa) was determined in the same manner as (4) Low Temperature Flexibility 1 except that the measurement temperature was changed to −40° C.

(6) Extrusion Processability:

Using a single screw extruder (L/D=28) and a T die, extrusion molding of a tape having a width of 20 mm and a thickness of 0.5 mm was performed under conditions of a die exit resin temperature of 180° C. The extrusion loading and the appearance of the resulting tape were evaluated according to the following criteria.

A: The appearance of the obtained tape is good.

B: The surface of the tape is rough. Further, a few defective spots are found.

C: Roughness is recognized on the tape surface. Further, many defective spots are found.

TABLE 1

| | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Formulation | a1-1 | 40 | 55 | 62 | 75 | 88 | 93 | 100 | |
| (parts by mass) | a1-2 | | | | | | | | 75 |
| | a2-1 | 60 | 45 | 38 | 25 | 12 | 7 | | 25 |
| | a2-2 | | | | | | | | |
| | a2′-1 | | | | | | | | |
| | B-1 | 25 | 25 | 25 | 25 | 25 | 25 | 25 | 25 |
| | B-2 | | | | | | | | |
| | B-3 | | | | | | | | |
| | B-4 | | | | | | | | |
| | C-1 | 4 | 4 | 4 | 4 | 4 | 4 | 4 | 4 |
| | C-2 | | | | | | | | |
| | C-3 | | | | | | | | |
| | C-4 | | | | | | | | |
| Evaluation | Hardness | 58 | 61 | 63 | 68 | 70 | 71 | 72 | 69 |
| results | Cold Resistance, ° C. | −33 | −29 | −25 | −21 | −13 | −11 | −6 | −22 |
| | Abrasion Resistance, times | 280 | 410 | 430 | 540 | 650 | 690 | 720 | 590 |
| | Low Temperature Flexibility 1, MPa | 1240 | 1410 | 1480 | 1600 | 1770 | 1790 | 2050 | 1630 |
| | Low Temperature Flexibility 2, MPa | 1410 | 1560 | 1600 | 1780 | 1980 | 2050 | 2300 | 1820 |
| | Extrusion Processability | A | A | A | A | A | A | A | A |

TABLE 2

| | | Ex. 9 | Ex. 10 | Ex. 11 | Ex. 12 | Ex. 13 | Ex. 14 | Ex. 15 | Ex. 16 |
|---|---|---|---|---|---|---|---|---|---|
| Formulation | a1-1 | 75 | 75 | 75 | 75 | 75 | 75 | 75 | 75 |
| (parts by mass) | a1-2 | | | | | | | | |
| | a2-1 | | | 25 | 25 | 25 | 25 | 25 | 25 |
| | a2-2 | 25 | | | | | | | |
| | a2′-1 | | 25 | | | | | | |
| | B-1 | 25 | 25 | 8 | 15 | 45 | 55 | | |
| | B-2 | | | | | | | 25 | |
| | B-3 | | | | | | | | 25 |
| | B-4 | | | | | | | | |
| | C-1 | 4 | 4 | 4 | 4 | 4 | 4 | 4 | 4 |
| | C-2 | | | | | | | | |
| | C-3 | | | | | | | | |
| | C-4 | | | | | | | | |
| Evaluation | Hardness | 69 | 61 | 77 | 73 | 47 | 39 | 69 | 67 |
| results | Cold Resistance, ° C. | −18 | −7 | 0 | −11 | −30 | −37 | −25 | −29 |
| | Abrasion Resistance, times | 530 | 210 | 980 | 690 | 320 | 230 | 555 | 530 |
| | Low Temperature Flexibility 1, MPa | 1650 | 1950 | 1950 | 1790 | 1320 | 1100 | 1490 | 1370 |
| | Low Temperature Flexibility 2, MPa | 1810 | 2120 | 2250 | 2080 | 1490 | 1230 | 1680 | 1560 |
| | Extrusion Processability | A | C | B | A | A | B | A | A |

TABLE 3

| | | Ex. 17 | Ex. 18 | Ex. 19 | Ex. 20 | Ex. 21 | Ex. 22 | Ex. 23 |
|---|---|---|---|---|---|---|---|---|
| Formulation | a1-1 | 75 | 75 | 75 | 75 | 75 | 75 | 75 |
| (parts by mass) | a1-2 | | | | | | | |
| | a2-1 | 25 | 25 | 25 | 25 | 25 | 25 | 25 |
| | a2-2 | | | | | | | |
| | a2′-1 | | | | | | | |
| | B-1 | | 25 | 25 | 25 | 25 | 25 | 25 |
| | B-2 | | | | | | | |
| | B-3 | | | | | | | |
| | B-4 | 25 | | | | | | |
| | C-1 | 4 | | 1 | | | | |
| | C-2 | | | | 15 | 4 | | |
| | C-3 | | | | | | 4 | |
| | C-4 | | | | | | | 4 |
| Evaluation | Hardness | 68 | 71 | 71 | 63 | 68 | 68 | 68 |
| results | Cold Resistance, ° C. | −20 | −12 | −15 | −31 | −19 | −20 | −18 |
| | Abrasion Resistance, times | 560 | 710 | 680 | 350 | 530 | 550 | 560 |
| | Low Temperature Flexibility 1, MPa | 1590 | 1790 | 1740 | 1380 | 1630 | 1670 | 1690 |
| | Low Temperature Flexibility 2, MPa | 1780 | 2080 | 2040 | 1610 | 1810 | 1860 | 1890 |
| | Extrusion Processability | A | A | A | A | A | A | A |

The thermoplastic resin composition of the present invention is excellent in abrasion resistance and extrusion processability. The thermoplastic resin composition according to the preferred aspect of the present invention is excellent in abrasion resistance, cold resistance, flexibility at low temperature, and extrusion Processability. Therefore, the thermoplastic resin composition of the present invention can be suitably used as a coating material for electric wires for mounting on automobiles.

1. A thermoplastic resin composition for an electric wire coating, the thermoplastic resin composition comprising
(A) 100 parts by mass of a thermoplastic resin and
(B) 10 to 50 parts by mass of a plasticizer,
the thermoplastic resin (A) comprising
(a1) 50 to 95% by mass of a vinyl chloride resin and
(a2) 50 to 5% by mass of one or more selected from the group consisting of: a copolymer of an ethylene-vinyl acetate copolymer and vinyl chloride; and a copolymer of an ethylene-vinyl acetate copolymer, vinyl chloride and a monomer copolymerizable with the vinyl chloride, wherein the total of the component (a1) and the component (a2) is 100% by mass.

2. The thermoplastic resin composition for an electric wire coating according to claim 1, wherein the component (a2) is one or more selected from the group consisting of: a graft copolymer of an ethylene-vinyl acetate copolymer and vinyl chloride; and a graft copolymer of an ethylene-vinyl acetate copolymer, vinyl chloride and a monomer copolymerizable with the vinyl chloride.

3. The thermoplastic resin composition for an electric wire coating according to claim 1, wherein the plasticizer (B) is one or more selected from the group consisting of polyester plasticizers, trimellitates plasticizers and phthalates plasticizers.

4. The thermoplastic resin composition for an electric wire coating according to claim 1, further comprising 1 to 15 parts by mass of one or more component (C) selected from the group consisting of a nitrile rubber based material other than fully cross-linked nitrile rubber, a core shell rubber and a thermoplastic elastomer having a hydrophilic functional group, with respect to 100 parts by mass of the thermoplastic resin (A).

5. An electric wire comprising the thermoplastic resin composition for an electric wire coating according to claim 1.

6. A wire harness comprising the electric wire according to claim 5.
